(19) United States
(12) Patent Application Publication
(10) Pub. No.: US 2006/0196999 A1
(43) Pub. Date: Sep. 7, 2006

(54) Paint can support device for ladders

(76) Inventors: Shawn W. Owens, Plattsmouth, NE (US); Diana Kay Owens, Plymouth, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/346,506

(22) Filed: Feb. 2, 2006

Related U.S. Application Data
(60) Provisional application No. 60/649,410, filed on Feb. 2, 2005.

(51) Int. Cl. E06C 7/14

(52) U.S. Cl. 248/210

(57) ABSTRACT

A paint can support device for ladders having rungs includes a support shaft and a paint can cradle structure mounted on and depending downwards from one end of the support shaft, the paint can cradle structure having at least one side can support strut and being free of base support means for the paint can. A paint can handle engagement pin is mounted on and extends upwards from the support shaft generally adjacent the paint can cradle structure operative to releasably engage the handle of a paint can whereby the paint can depends therefrom to be cradled by the paint can cradle structure. Finally, a support shaft ladder securement device is mounted on the support shaft for releasably securing the support shaft on one of the rungs of a ladder.

### CROSS-REFERENCE TO RELATED PROVISIONAL PATENT

This application claims priority based on a provisional patent, specifically on the Provisional Patent Application Ser. No. 60/649,410 filed Feb. 2, 2005.

### BACKGROUND OF THE INVENTION

1. Technical Field

The present invention is directed to paint support devices for ladders and, more particularly, to a ladder-mounted paint can support device which includes a longitudinally extended support shaft having a securement device mounted at one end and a paint can support structure mounted at the opposite end thereof, the paint can support structure including a downwardly depending generally upright strut and at least one generally arcuate can engagement arm extending generally perpendicular to the upright strut for cradling the paint can therein and a paint can handle support pin mounted on the support shaft generally adjacent the upright strut which extends upwards and inwards from the support shaft to permit a paint can handle to extend around the pin and support the paint can adjacent to and cradled by the paint can support structure.

2. Description of the Prior Art

It is common knowledge that the painting of the walls and ceiling of a structure generally requires the painter to use a ladder or other elevation device to reach the location to be painted. In the vast majority of painting jobs, the painter would use either a step ladder or an extension ladder, would place the ladder in a secure, generally level location, and then would climb the ladder to reach the location to be painted. Of course, once the painter is on the ladder adjacent the location to be painted, he or she must have easy access to the paint which is to be applied to the wall or ceiling of the structure. There is therefore a need for a device which can support paint in a location on or near a ladder for use by a person standing on the ladder.

There have been numerous attempts in the prior art to provide support devices which mount on ladders for the purpose of supporting paint in an accessible location for the painter. These include such inventions as Bermes, U.S. Pat. No. 6,241,204, which discloses a paint bucket holder having a support box for the paint bucket and a rigid arm adapted to fit within the hollow rung of an extension ladder, McGraw, U.S. Pat. No. 5,316,251, which discloses a self-leveling paint can holder for hollow rung ladders, and Korda, U.S. Pat. No. 4,824,060, which discloses a shaft extending through the hollow rung of an aluminum ladder which includes a cradle having a base wall which supports the weight of the can in the cradle. While each of these devices generally solve the problem of supporting a paint can on a ladder, each of them has inherent deficiencies which do not completely solve the problems of providing easy adjustment of the height of the paint can support device on the ladder and permitting the installation and replacement of various sizes of paint cans by a simple operation. There is therefore a need for an improved paint can support device for ladders which addresses and corrects the problems found in the prior art.

Therefore, an object of the present invention is to provide an improved paint can support device for ladders.

Another object of the present invention is to provide a paint can support device for ladders which includes a support shaft, a paint can cradle structure mounted on and depending downwards from one end of the support shaft and a paint can handle engagement pin mounted on the support shaft for releasably engaging a handle of a paint can so that the paint can hangs within the paint can cradle structure from the paint can handle.

Another object of the present invention is to provide a paint can support device for ladders in which paint can cradle structure does not include any type of support structure for the base of the paint can.

Another object of the present invention is to provide a paint can support device for ladders which can be quickly and easily moved from one rung of the ladder to another and which can support paint cans of many different sizes and shapes.

Another object of the present invention is to provide a paint can support device for ladders which is also usable on wooden ladder and ladders without hollow rungs.

Finally, an object of the present invention is to provide a paint can support device for ladders pad which is relatively simple and durable in manufacturing and is safe, effective, and efficient in use.

### SUMMARY OF THE INVENTION

The present invention provides a paint can support device for ladders having rungs, the paint can support device including a support shaft and a paint can cradle structure mounted on and depending downwards from one end of the support shaft, the paint can cradle structure having at least one side can support strut and being free of base support means for the paint can. A paint can handle engagement pin is mounted on and extends upwards from the support shaft generally adjacent the paint can cradle structure operative to releasably engage the handle of a paint can whereby the paint can depends therefrom to be cradled by the paint can cradle structure. Finally, a support shaft ladder securement device is mounted on the support shaft for releasably securing the support shaft on one of the rungs of a ladder.

As thus described, the paint can support device for ladders pad of the present invention provides numerous advantages over those paint can support devices found in the prior art. For example, because the paint can support device of the present invention does not include a paint can base support, the number of different sizes and shapes of cans supportable by the present invention is much greater than that found in those devices found in the prior art. Furthermore, because the support shaft merely slides into the hollow rung of the ladder to mount the device on the ladder, the paint can support device may be quickly and easily moved to a different location on the ladder even while the ladder is in use. Finally, because the paint can cradle structure of the present invention engages and cradles the sides of the paint can when the paint can is being supported by the paint can handle engagement pin, undesirable movement of the paint can such as swinging or shifting is greatly reduced, thus making use of the present invention safer. The paint can support device for ladders of the present invention thus provides a substantial improvement over those ladder-mounted paint support devices found in the prior art.

### BRIEF DESCRIPTION OF THE DRAWINGS

FIG. 1 is a perspective view of the paint can support device for ladders of the present invention mounted on a ladder;

FIG. 2 is a perspective view of the present invention;

FIG. 3 is a detail side elevational view of the present invention;

FIG. 4 is a perspective view of an alternative embodiment of the paint can support device for ladders of the present invention mounted on a ladder; and

FIG. 5 is a perspective view of the embodiment of FIG. 4.

### DESCRIPTION OF THE PREFERRED EMBODIMENT

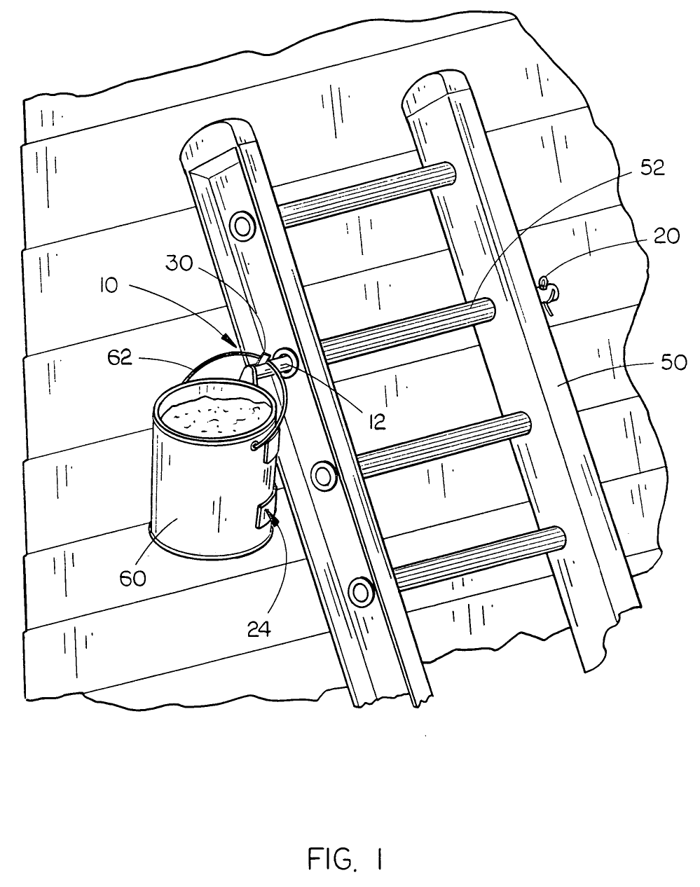

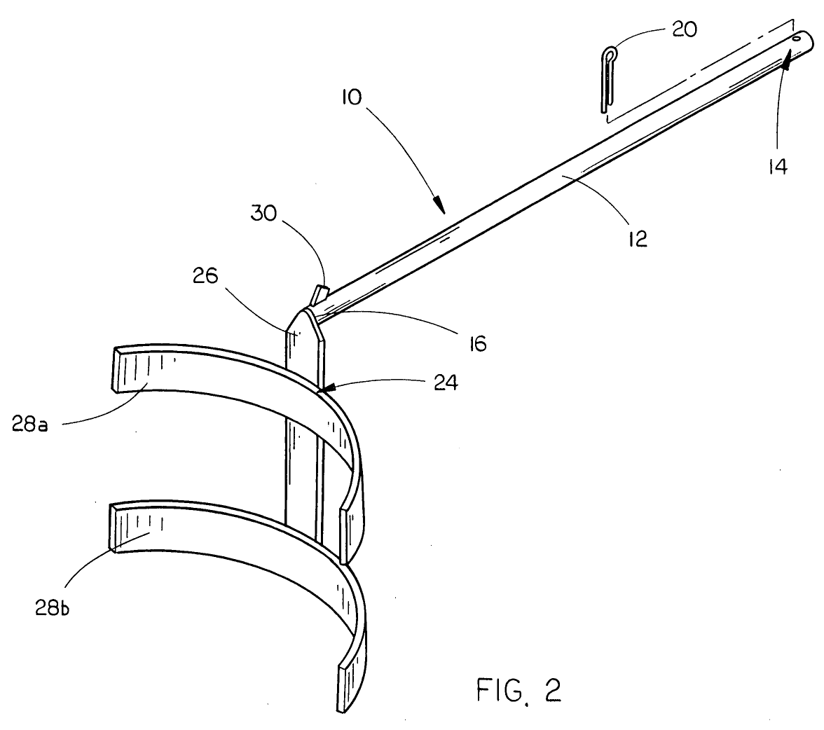

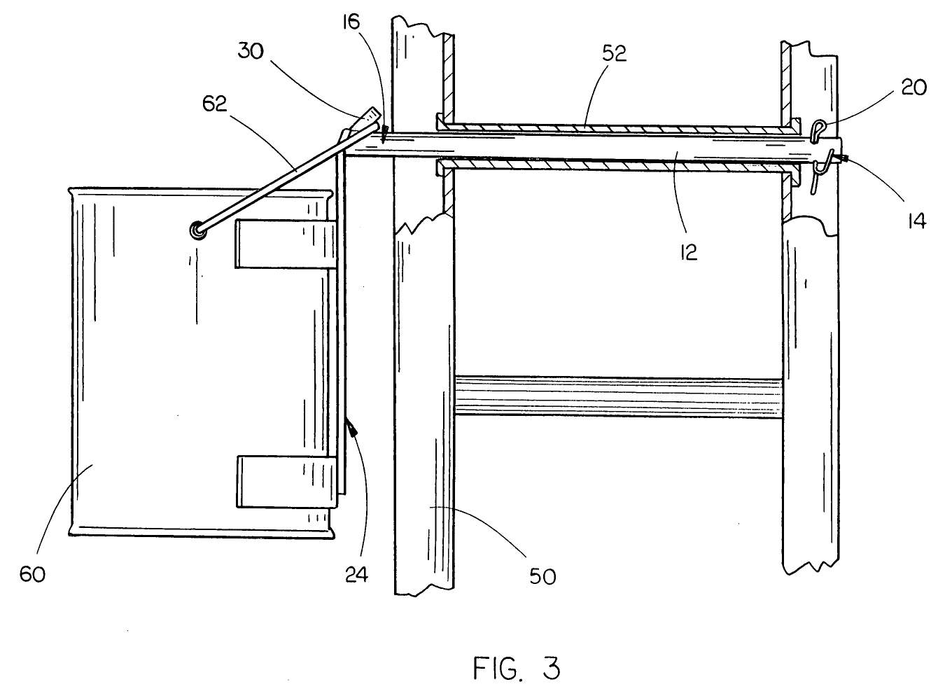

The paint can support device 10 of the present invention is shown best in FIGS. 1-3 as including a support shaft 12 which, in the preferred embodiment, would be constructed of hollow steel tubing having a diameter of approximately one-half to three quarters of an inch and a length of approximately eighteen to twenty-four inches, depending on the width of the ladder 50 on which the paint can support device 10 is to be mounted. The precise size and shape of the support shaft 12 is not critical to the present invention so long as it provides sufficient structural support for the paint can 60 which is to be suspended from the paint can support device 10 and is of small enough diameter to fit within the hollow rung 52 of the ladder 50, as shown best in FIGS. 1 and 3. Mounted on the outer end 14 of support shaft 12 is a securement pin 20 which extends through the support shaft 12, as shown best in FIG. 2, to releasably retain the support shaft 12 within the hollow rung 52 of the ladder 50. Of course, the securement pin 20 may be of any appropriate size, shape, or design so long as the intended function of preventing the support shaft 12 from falling out of the hollow rung 52 of ladder 50 is maintained. For example, the securement pin 20 may be replaced by a washer or any other appropriate securement device such as a small clamp to releasably retain the support shaft 12 within hollow rung 52.

Mounted on and extending downwards from support end 16 of support shaft 12 is paint can cradle structure 24 which, in the preferred embodiment, would include the following elements. A generally upright strut 26 is mounted on and extends downwards from the support end 16 of support shaft 12, the generally upright strut 26 having a length of approximately six to eighteen inches and preferably being constructed of a section of metal plate having a thickness of approximately one-eighth inch. Mounted on and extending perpendicularly from generally upright strut 26 are a pair of generally arcuate paint can cradle bars 28a and 28b, which, in the preferred embodiment, would each have a length of approximately four to twelve inches and would be curved to approximate the curvature of a paint can with which the paint can support device 10 of the present invention is intended to be used. To this end, the curvature of the paint can cradle bars 28a and 28b may be modified or changed to accommodate various sizes of paint cans, from the standard one gallon paint can up to the commercial size five gallon paint can, and it is intended that the paint can cradle bars 28a and 28b be constructed of sheet metal which is generally rigid but may be bent by application of force to modify the arcuate curvature of the paint can cradle bars 28a and 28b. Of course, it should be noted that the precise construction characteristics of the paint can cradle structure 24 may be modified or changed so long as the intended function of generally cradling the paint can 60 is maintained, and therefore the precise size, shape and construction materials used for the elements thereof may be modified or changed. However, it is important to note that the paint can cradle structure 24 has been intentionally designed to not include any structural element designed to support the paint can 60 from underneath, as it has been found that such a design limits the size of the paint can 60 which may be supported by the paint can support device 10 of the present invention. Therefore, the present invention requires a different support structure for the paint can 60, one which lends a high degree of novelty to the present invention and renders it unlike those other paint can support devices found in the prior art.

Specifically, the paint can support device 10 of the present invention further includes a paint can handle support pin 30 which is mounted on the support shaft 12 generally adjacent the support end 16 thereof, the paint can handle support pin 30 extending upwards and inwards from the support shaft 12 and having a length of approximately one-half inch to two inches, as shown best in FIGS. 1 and 2. In operation, the paint can handle support pin 30 is designed to engage and secure the paint can handle 62 of paint can 60 as the paint can handle 62 is extended over and around the paint can handle support pin 30, as shown in FIGS. 1 and 3. The paint can 60 would then hang downwards from the paint can handle support pin 30 and be cradled within paint can cradle structure 24, specifically by paint can cradle bars 28a and 28b, to restrict the lateral motion of the paint can 60 while secured on the paint can support device 10 of the present invention. As the vast majority of paint cans 60 are specifically designed to be supported by their paint can handle 62, it is a logical use of the paint can handle 62 to support the paint can 60 on the paint can support device 10. Moreover, as the paint can handle 62 is extended over and around the paint can handle support pin 30 and is secured thereon only by the weight of the paint can 60 exerting downward force on the paint can handle 62 and the height and angle of the paint can handle support pin 30, it is a simple matter to install and/or replace the paint can 60 from the paint can support device 10 of the present invention. One would merely lift the paint can 60 by the paint can handle 62 until the paint can handle 62 can be slid over and off of the paint can handle support pin 30. A new paint can would then be secured on the paint can support device 10 by slipping the paint can handle 62 over the paint can handle support pin 30 to permit the painter to continue painting without significant interruption of his or her painting schedule.

It should be noted that the exact design of the paint can handle support pin 30 is not critical to the present invention so long as the functional characteristics of the paint can handle support pin 30 are maintained. For example, the paint can handle support pin 30 may be triangular in design or may be of any other type of shape which provides sufficient support for the paint can 60 through engagement of the paint can handle 62 when the paint can 60 is supported on the paint can support device 10 of the present invention. Such modifications would be understood by those skilled in the art of object fabrication and should be deemed to be a part of this disclosure.

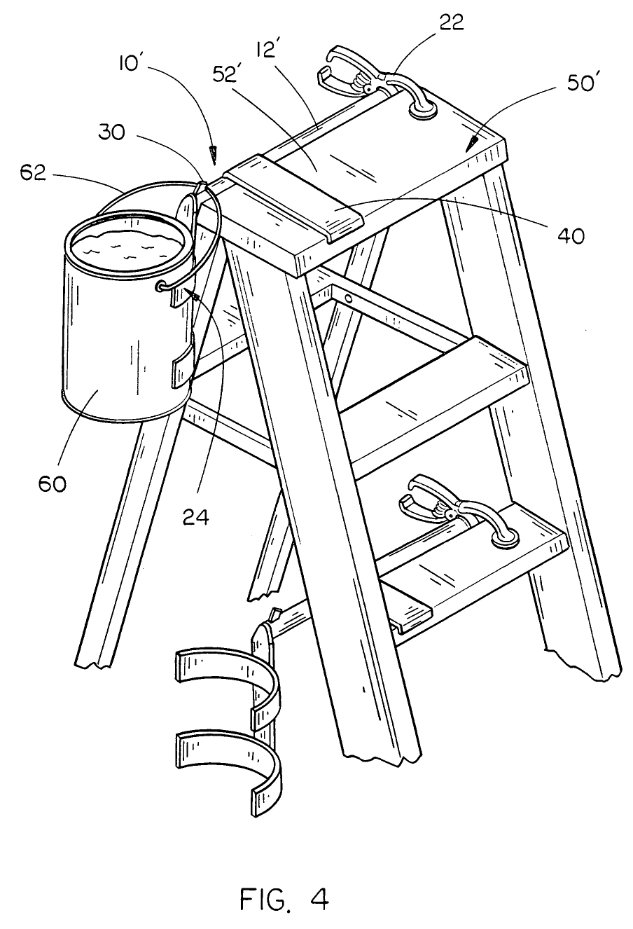

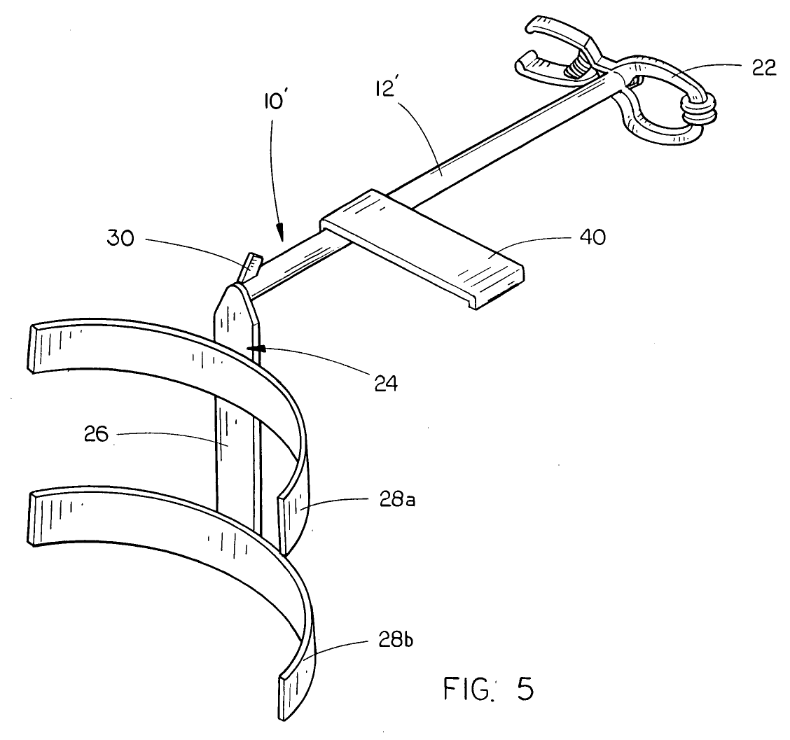

An alternative embodiment of the present invention is shown in FIGS. 4 and 5 as being generally identical with regards to the paint can cradle structure 24 and paint can handle support pin 30. However, the significant difference in the paint can support device 10′ shown in FIG. 3 relates to the support shaft 12′ and, particularly, to the securement device 20′ mounted at the outer end 14′ of the support shaft 12′. The paint can support device 10′ shown in FIG. 4 is designed to be mounted on a stepladder 50′ of the type having solid rungs 52′ (i.e. a wooden stepladder) instead of the hollow rungs described above in connection with the first embodiment of the present invention. On such a stepladder 50′, the support shaft 12′ would be mounted to the selected ladder rung 52′ by a clamp device 22 which functions as the securement pin 20 in the first embodiment in that motion of the support shaft 12′ is generally prevented by the releasable clamp 22 which engages the selected ladder step. The paint can support device 10′ of FIG. 3 further includes a rotation stop plate 40 which extends laterally outwards from the support shaft 12′ to generally prevent rotation of the support shaft 12′ relative to the ladder step on which the support shaft 12′ is mounted. Of course, numerous other designs may be utilized in connection with the embodiment of FIG. 3, any of which would be suitable for use with the present invention so long as the critical paint can support elements are maintained. Such modifications would be understood by one skilled in the art of mounting devices on ladders.

One of the distinct advantages of the paint can support device 10 of the present invention is that it may be used on either side of a ladder 50 merely by removing the support shaft 12 from the hollow rung 52 in which it is mounted and replacing it on the opposite side of the hollow rung 52. This will permit easy use of the present invention regardless of the location being painted or of the hand use predilection of the painter. Also, because the present invention fits within the hollow rung 52 of the ladder 50 and is secured therein by securement pin 20, adjustment of the height of the ladder 50 does not necessitate removal and replacement of the paint can support device 10 from the ladder 50 during such adjustment. Once again, this characteristic provides a substantial improvement over the prior art as the ease and efficiency of use of the present invention is enhanced.

It is to be understood that numerous additions, modifications, and substitutions may be made to the paint can support device 10 of the present invention which fall within the intended broad scope of the above description. For example, the size, shape, and construction materials used in connection with the paint can support device 10 may be modified or changed so long as the functional characteristics of the invention are maintained. For example, it may be beneficial to construct the entire paint can support device 10 out of a molded plastic material, provided such material is sturdy and capable of supporting the weight of the paint can 60 when it is placed on the paint can support device 10. Also, the precise positioning of the paint can handle support pin 30 on support shaft 12 may be modified or changed depending on the size of the paint can handle 62 and the design thereof. Such modifications should be understood to be a part of this disclosure. Finally, the design of the paint can cradle structure 24 may be modified or changed to appropriately support the paint can 60 thereon, so long as the paint can cradle structure 24 does not include additional support structures for supporting the base of the paint can 60, as such a structure would degrade the performance of the paint can support device 10 of the present invention.

There has therefore been shown and described a paint can support device 10 which accomplishes at least all of its intended purposes.

I claim:

1. A paint can support device for ladders having rungs, said paint can support device comprising:
a support shaft;
a paint can cradle structure mounted on and depending downwards from one end of said support shaft, said paint can cradle structure having at least one side can support strut and being free of base support means for the paint can;
paint can handle engagement means mounted on and extending upwards from said support shaft generally adjacent said paint can cradle structure operative to releasably engage the handle of a paint can whereby the paint can depends therefrom to be cradled by said paint can cradle structure; and
support shaft ladder securement means mounted on said support shaft for releasably securing said support shaft on one of the rungs of a ladder.

2. The paint can support device for ladders of claim 1 wherein said support shaft comprises a generally cylindrical straight metal bar having a length exceeding the width of the ladder on which said device is to be mounted.

3. The paint can support device for ladders of claim 1 wherein said paint can cradle structure comprises a generally upright strut mounted on and extending downwards from said one end of said support shaft and at least one generally arcuate paint can cradle bar mounted on and extending generally perpendicularly outwards on both sides of said generally upright strut, said at least one generally arcuate paint can cradle bar having a longitudinal arcuate shape which approximates the curvature of a paint can to be releasably supported on said paint can support device.

4. The paint can support device for ladders of claim 3 wherein comprising two generally parallel generally arcuate paint can cradle bars.

5. The paint can support device for ladders of claim 1 wherein said paint can handle engagement means comprises a paint can handle engagement pin mounted on and extending upwards and inwards from said support shaft.

6. The paint can support device for ladders of claim 1 wherein said support shaft ladder securement means comprises a securement pin removably mounted on the outer end of said support shaft and which extends through said support shaft to releasably retain said support shaft on the selected rung of the ladder.

7. The paint can support device for ladders of claim 1 wherein said support shaft ladder securement means comprises a clamping device mounted on said support shaft operative to releasably retain said support shaft on the selected rung of the ladder.

8. A paint can support device for ladders having hollow rungs, said paint can support device comprising:
a support shaft;
a paint can cradle structure mounted on and depending downwards from one end of said support shaft, said paint can cradle structure having at least one side can support strut and being free of base support means for the paint can;
a paint can handle engagement pin mounted on and extending upwards and inwards from said support shaft generally adjacent said paint can cradle structure operative to releasably engage the handle of a paint can extended there over whereby the paint can depends therefrom to be cradled by said paint can cradle structure; and
a clamping device mounted on said support shaft operative to releasably engage and retain the selected rung of the ladder thereby releasably securing said support shaft on the ladder.

9. A paint can support device for ladders having rungs, said paint can support device comprising:
a support shaft;
a paint can cradle structure mounted on and depending downwards from one end of said support shaft, said paint can cradle structure having at least one side can support strut and being free of base support means for the paint can;
a paint can handle engagement pin mounted on and extending upwards and inwards from said support shaft generally adjacent said paint can cradle structure operative to releasably engage the handle of a paint can extended there over whereby the paint can depends therefrom to be cradled by said paint can cradle structure; and
a securement pin removably mounted on the outer end of said support shaft and which extends through said support shaft to releasably retain said support shaft on the selected hollow rung of the ladder when said support shaft extends through the selected hollow rung.
